(19) United States
(12) Patent Application Publication
(10) Pub. No.: US 2005/0044235 A1
(43) Pub. Date: Feb. 24, 2005

(54) System, computer product and method for enabling wireless data synchronization

(76) Inventors: Robert Eugene Balahura, Waterloo (CA); Aaron James Barnes, Brussels (CA)

Correspondence Address: MILLER THOMPSON, LLP, 20 QUEEN STREET WEST, SUITE 2500, TORONTO, ON, M5H 3S1, CA

(21) Appl. No.: 10/902,165

(22) Filed: Jul. 30, 2004

Related U.S. Application Data
(60) Provisional application No. 60/490,933, filed on Jul. 30, 2003.

(51) Int. Cl. G06F 15/16; G06F 15/173

(52) U.S. Cl. 709/227; 709/228; 709/223

(57) ABSTRACT

A system, computer program and method for enabling wireless data synchronization between a client computer and a wireless device is provided. The client computer includes a client application, the wireless device includes a wireless application, and an intermediary server operable to connect to each of the client computer and the wireless device includes a server application and a server database. The client application includes an update management facility that is operable to enable a user of the client computer to: selectively determine one or more data objects on the database for synchronization as between the intermediary server and the wireless device; and to establish one or more parameters of synchronization as between the intermediary server and the wireless device. The client computer is operable to communicate the data objects to the intermediary server, which data objects are stored by the intermediary server to the server database. The wireless application is operable to poll the intermediary server for one or more updates including the data objects from the client computer and in response to such polling the intermediary server is operable to retrieve the data objects from the server database and communicate such data objects to the wireless device. The client application is further operable to map a database linked to the client computer to define target data for synchronization with the wireless device via the intermediary server.

### FIELD OF THE INVENTION

This invention relates in general to a system, computer product and method for enabling synchronization of data associated with a wireless device with data associated with a remote network-connected device. This invention further relates generally to mobile workforce technology solutions.

### BACKGROUND OF THE INVENTION

Wireless devices of numerous types are commonplace. First, there are WAP-enabled cell phones. These devices generally have a small text display. Second, there are 2-way pager devices. These devices generally establish “session-less” connections to the Internet, i.e. they send and receive messages without the overhead of logging in, establishing credentials, etc. Examples of such 2-way paging devices include RIM's Blackberry™ pager that includes a memory. A third type of wireless device is known as a Wireless Personal Digital Assistant (PDA) or wireless terminal. These devices provide a small screen and permit inputting of text. Some wireless terminals include an ASCII keyboard. The wireless terminal operates similarly to the WAP-enabled cell phone, except the wireless terminal can generally support a richer user experience, e.g. color screens and audio output and generally have more processing capability than WAP-enabled cell phones. A fourth type of device is referred to as a Wireless Pocket PC which usually has high resolution and color screen and permits a user to set up a connection session to the Internet. A fifth type of device is a cell phone that provides wireless Internet access using network connectivity other than WAP and in association with applications resident on the wireless device. Another aspect of such wireless devices is that they generally include a memory, such that applications can be loaded on the device, and data can be stored on the device itself.

Wireless devices that include a memory, such that they can receive applications and can store data to the memory are referred to generally as a “Wireless Device” or “Wireless Devices” throughout the present disclosure. Examples of such Wireless Devices include, for example, MOTOROLA's T720 and the Blackberry™. See www.microiava.com for other devices.

A common desire is to access data at wireless devices from remote locations. One of the objects of related technology solutions is to enable selective remote access to data associated with a remote computer, whether a server computer or desktop application. The data of interest is extremely varied and includes contact information, notes regarding a potential customer, product delivery status data, manufacturing status data, system performance data, account information, stock quotes, news and so on.

Numerous solutions are known for making data from a remote location accessible at a wireless device, including for example MOTIVUS™, EUDORAWEB™, I'M IN TOUCH™ and others.

A particular aspect of technology solutions that make data accessible from a remote location at a wireless device, is supporting the “Mobile Workforce” through technology. The “Mobile Workforce” generally refers to staff members of a business who do all or part of their work out of the office. The Mobile Workforce ordinarily uses one or more wireless devices such as the wireless devices described above. The wireless device is generally integrated with a business system that creates or incorporates data where access to this data at the wireless devices is advantageous.

A typical example is an enterprise “Customer Relationship Management” (“CRM”) such as ACT!™ or GOLDMINE™. An object of remote access to data is to enable the Mobile Workforce to obtain important data updates from the CRM system.

Updates to wireless devices are also obtained from systems with different objects such as email systems, voice systems, medical dictation and transcription systems, prescription systems, and so on.

Prior art systems directed at providing updates from a remote network-connected computer to wireless devices generally involve an enterprise solution. This means that the application creating or storing the data, in relation to which access at the Wireless Device is desired, is generally part of a server solution.

An example of such an enterprise solution is disclosed in U.S. Pat. No. 6,336,137 issued to Siebel Systems. It discloses a server solution that provides interoperability and compatibility between a plurality of browsers, browser protocols, and page delivery and mark up languages and a server system, for the purpose of sending updates to a wireless client utilizing the Wireless Application Protocol and the Wireless Markup Language.

Such enterprise solutions are generally expensive to acquire, implement, integrate and maintain. Particularly as the needs of a Mobile Workforce evolve over time, deployment of a particular enterprise solution may in some cases limit the nature and operation of the applications that are the object of data synchronization with a wireless device.

There is a need therefore for a computer device to Wireless Device data synchronization solution that is easy and inexpensive to deploy. There is a further need for a computer device to Wireless Device data synchronization facility that enables data synchronization between one or more computers and one or more Wireless Devices. There is a further need for a computer device to Wireless Device data synchronization facility that enables data synchronization integrated with one or more desktop applications on a flexible basis, for synchronization between such desktop applications and the wireless devices.

The J2ME™ platform refers to the “JAVA 2 PLATFORM, MICRO EDITION” which is a JAVA™ based platform from Sun Microsystems for consumer and embedded devices such as mobile phones, PDAs, and TV set-top boxes. One aspect of J2ME is that it enables rapid deployment of applications on Wireless Devices by providing a series of tools including easy to use API's, user interfaces, security features, support for networked and disconnected applications, and tools for managing the resources of particular wireless devices.

There is a further need for a solution that leverages J2ME to provide data synchronization as between one or more J2ME compliant wireless devices and one or more remote computer devices. There is a further need for a particular system architecture that enables the leveraging of J2ME to provide data synchronization as between one or more J2ME compliant wireless devices and one or more remote computer devices.

### SUMMARY OF THE INVENTION

One object of the present invention provides a system, computer product and method for two-way data syncing as between a desktop computer and a Wireless Device via an intermediary server.

The desktop application includes an update management facility that enables a user to select the parameters of syncing of data as between the desktop computer and the Wireless Device. Updates are sent to the intermediary server and stored to a server database. The wireless application of the present invention linked to the Wireless Device polls the intermediary server for specific updates on intervals defined by the update management facility. The wireless application in turn send updates to the intermediary server, also on intervals established by the update management facility. The desktop computer also polls the intermediary server from updates received from the Wireless Device.

In one aspect of the present invention, there is provided a system for enabling wireless data synchronization between a client computer and a wireless device comprising a client computer including a client application, and linked to a database a wireless device including a wireless application, and linked to a memory; and an intermediary server operable to connect to each of the client computer and the wireless device, the intermediary server including a server database; wherein the client application includes an update management facility that is operable to enable a user of the client computer to: selectively determine one or more data objects on the database for synchronization as between the intermediary server and the wireless device; and establish one or more parameters of synchronization as between the intermediary server and the wireless device; wherein the client computer is operable to communicate the data objects to the intermediary server, which data objects are stored by the intermediary server to the server database; and wherein the wireless application is operable to poll the intermediary server for one or more updates including the data objects from the client computer and in response to such polling the intermediary server is operable to retrieve the data objects from the server database and communicate such data objects to the wireless device.

In another aspect of the present invention, there is provided a computer program for use on a client computer, the client computer being linked to a database, for managing data synchronization as between the client computer and a wireless device via an intermediary server operable to connect to each of the client computer and the wireless device, the intermediary server including a server database, the computer program comprising instructions for defining on the client computer: an update management facility that is operable to enable a user of the client computer to: selectively determine one or more data objects on the database for synchronization as between the intermediary server and the wireless device; and establish one or more parameters of synchronization as between the intermediary server and the wireless device; wherein the client computer is operable to communicate the data objects to the intermediary server, which data objects are stored by the intermediary server to the server database; and wherein the wireless device by operation of a wireless application polls the intermediary server for one or more updates from the client computer, and in response to such polling the intermediary server is operable to retrieve the data objects from the server database and communicate such data objects to the wireless device.

In yet another aspect of the present invention, there is provided a server computer program for use on a server computer, the server computer consisting of an intermediary server enabling data synchronization as between at least one client computer and at least one wireless device, the server computer program comprising instructions for defining on the server computer: a communication utility that enables communications between the intermediary server and each of the client computer and the wireless device; a user access facility that manages the access of one or more authorized users from the client computer and/or from the wireless device to resources of the intermediary server; and a database management facility that is operable to link data objects sent to the intermediary server from the client computer and/or the wireless device and stored to the server database with the applicable client computer and/or wireless device, and/or one or more applicable authorized users; wherein the server computer program is operable to enable the server computer to receive polling requests from each of the client computer and/or the wireless device, and in response to provide one or more updates to the other of the client computer and/or the wireless device, the updates consisting of data objects stored to the server database for synchronization, thereby achieving data synchronization as between the client computer and the wireless device.

In a further aspect of the present invention, there is provided a method for providing data synchronization as between at least one client computer and at least one wireless device comprising the steps of: loading a data synchronization application on each of the at least one client computer and at least one wireless device; establishing one or more criteria for a subset of data stored to a memory linked to each of the at least one client computer and the at least one wireless device, said subset of data consisting of target data for one or more updates, by operation of the data synchronization application; defining parameters for delivery of the one or more updates from one of the at least one client computer or the at least one wireless device to the other of the at least one client computer or the at least one wireless device, by operation of the data synchronization application; sending one or more updates from each of the at least one client computer and the at least one wireless device to an intermediary server as part of a data synchronization routine; and receiving updates at each of the at least one client computer or the at least one wireless device from the other of the at least one client computer or the at least one wireless device, via the intermediary server, by engaging the data synchronization routine from the at least one client computer or the at least one wireless device.

### BRIEF DESCRIPTION OF THE DRAWINGS

A detailed description of the preferred embodiment(s) is (are) provided herein below by way of example only and with reference to the following drawings, in which:

FIG. 1 is a system resource flowchart, in accordance with one aspect of the present invention, illustrating the connection of the system to a wireless network.

FIG. 2 is a program resource diagram illustrating the resources of the wireless application of the present invention.

FIG. 3 illustrates the functions of the desktop application of the present invention.

FIG. 4 further illustrates the resources of the intermediary server of the present invention.

FIG. 5 further illustrates the resources of the intermediary server of the present invention.

FIG. 6 is an architecture diagram illustrating the overall computer architecture and related processes of the present invention.

FIG. 7 illustrates one aspect of the method of the present invention whereby data is synced as between the wireless application and the intermediary server.

FIG. 8 illustrates another aspect of the method of the present invention whereby data is synced as between the desktop application and the intermediary server.

FIG. 9 illustrates the software functions of the wireless application of the present invention.

FIG. 10 illustrates the software functions of the desktop application of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

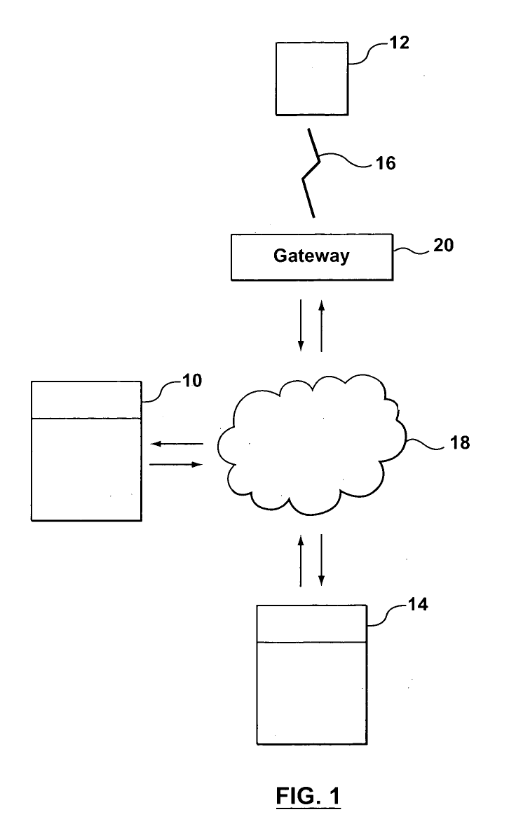

Referring to FIG. 1, there is illustrated in a system resource flowchart generally illustrating the resources of the present invention. One aspect of the present invention is a system for enabling data synchronization as between at least one network-connected device (10) or desktop computer and at least one Wireless Device (12) by means of the intermediary server (14).

The wireless device (12) is connected to a known wireless network (16). The wireless network (16) is connected to the Internet (18) by known means such as a wireless network gateway (20) that moves data communications between the Internet and the wireless network. The Wireless Device (12) is adapted to send data communications via the wireless network (16) to the wireless network gateway (20).

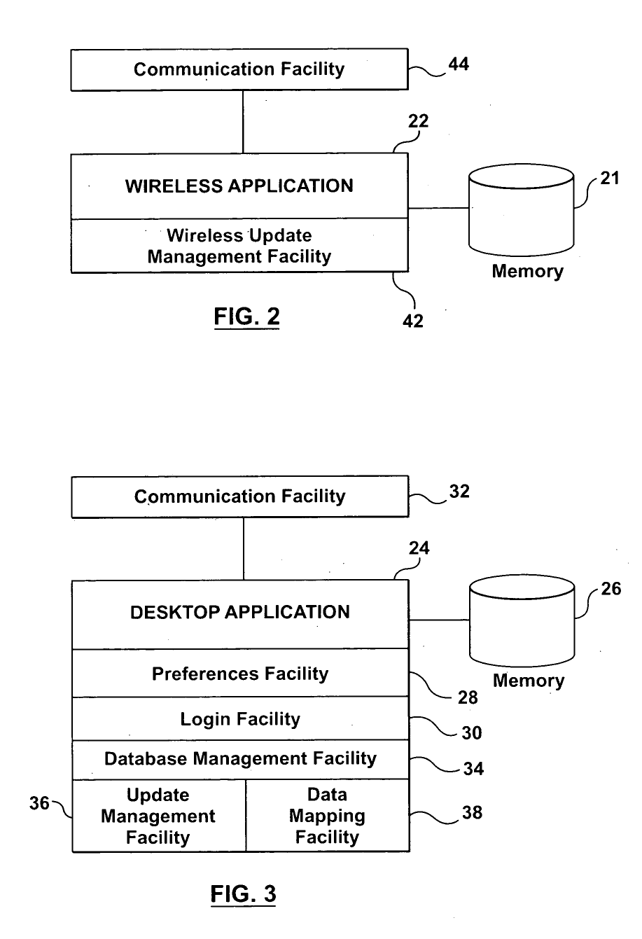

As illustrated in FIG. 2, the Wireless Device (12) further includes a memory (21) as illustrated in FIG. 2. A wireless application (22) of the present invention is loaded on the Wireless Device (12). The wireless application (22) enables Internet based communications with the intermediary server (14) and the network-connected device (10). The wireless application (22) is provided in a manner that is known. In one aspect of the wireless application (22), it is best understood as a connectivity computer program for enabling the communications particularized herein. In one particular embodiment of the wireless application (22), the wireless application (22) is built on an existing wireless communication platform such as J2ME™ (of Sun Microsystems) or BREW™ (of Qualcomm).

The network-connected device (10), is best understood as a known computer adapted to be connected to the Internet (18) such as a network station, personal computer terminal or server, embedded computer, set-top box or network gateway, provided in a manner that is known. The network-connected device (10) also includes a memory (not shown) and a microprocessor (not shown), provided in a manner that is known.

The intermediary server (14) is also provided in a manner that is known. It includes a web server, provided in a manner that is known. As shown in FIG. 1, the intermediary server (14) is connected to the Internet (18), preferably using a permanent Internet connection provided, for example, by a coaxial cable connection or high speed xDSL telephone connection or the like.

The desktop application (24) of the present invention is loaded on the network-connected device (10). The desktop application (24) is best understood as a facility for selective exchange of updates between the network-connected device (10) and the wireless device (12) via the intermediary server (14). The resources of the desktop application (24) are illustrated in FIG. 3.

It should be understood that the desktop application (24) can be part of a computer application that accesses, stores or generates data that is the object of selective exchange of updates between the network-connected device (10) and the Wireless Device (12) via the intermediary server (14). For example, the desktop application (24) described herein can be part of a computer application that generates target data including contact information, notes regarding a potential customer, product delivery status data, manufacturing status data, system performance data, account information, stock quotes, news or other information. This information is then generally stored to a database (26) linked with the desktop application (29). In one aspect of the present invention therefore, the desktop application (24) consists of a program resource for enabling selective exchange of data updates between the network-connected device (10) and the Wireless Device (12) via the intermediary server (14), wherein the data updates are generally obtained from the database (26).

Alternatively, the data updates are obtained from some other data source linked to the desktop application (24).

In a particular embodiment of the present invention, for example, the functions of the desktop application (24) particularized herein are accessed through a “WIRELESS SYNC” button or icon, provided in a manner that is known.

Alternatively, the desktop application (24) is a computer program that interfaces with one or more computer applications generating target data described above.

As best illustrated in FIG. 3, one aspect of the desktop application (24) is a preferences facility (26). The preferences facility (26) provides a series of screens in a manner that is known that enables the desktop application (24) to be set up for selective data exchange with the Wireless Device (12), using for example a series of drop-down menus and the like. These screens are adapted to obtain input, for example, of the particulars of the Wireless Device (12), including its model number, contact information, the attributes of the wireless network (16), and so on.

The desktop application (24) also includes a log-in facility (30). The purpose of the log-in facility is to administer the log-in of users associated with the desktop application (24) to the resources of the intermediary server (14). The preferences facility (28) enables authorized users of the desktop application (24) to establish authentication data such as usernane/password combinations which when presented to the log-in facility (30) enables access to the resources of the intermediary server (14), as particularized below.

The desktop application (24) includes or is associated with a communication facility (32) that enables data communications as between the network-connected device (10) and the intermediary server (14), as particularized herein. In particular, the communication facility (32) assembles an electronic communication including the IP address of the intermediary server (14) as the recipient and containing the update in a form that is understood by the database management facility (34) of the intermediary server (14) (as particularized below).

Another aspect of the desktop application (24) is an update management facility (36). The update management facility (36) is best understood as a program resource that enables the management of selective updates from the desktop application (24) as described herein. The update management facility (36) is generally a software utility that enables the user of the desktop application (24) to select on an ongoing basis particular target data associated with the desktop application (24) from database (26) to be synchronized as particularized below. This promotes efficient utilization of resources and user control of processes around data synchronization. Generally, this target data is stored to the database (26), or otherwise accessible from the desktop application (24).

One particular aspect of the update management facility (36) is a data mapping facility (38). The data mapping facility (38) maps data associated with the desktop application (24) that is available for data synchronization in accordance with the present invention. This generally means the mapping of data stored to the desktop database (26). This function of the update management facility (36) is engaged by the user of the desktop application (24) by engaging a “DATA TO SYNC” button or equivalent. In a particular embodiment of the present invention, this initiates the data mapping facility (38) to map the fields associated with the database (26) to generate a list of data objects generally corresponding to categories of data stored within the database (26) in a manner that is known. The update management facility (38) enables the user of the desktop application (24) to select (using for example a check box interface) the various categories of data for synchronization in accordance with the present invention.

The update management facility (36) also enables the user of the desktop application (24) to select the various parameters of data synchronization in accordance with the present invention. These parameters include, for example, time parameters. The time parameters include, for example, the commencement time and data for data synchronization; the frequency of data synchronization (e.g. every two minutes on weekdays, once an hour on the weekends). The update management facility (36) also enables the user of the desktop application to preferably shut data synchronization ON or OFF quickly and easily, for example, via an “WIRELESS SYNC ON/OFF” button or shortcut without having to drive down to the preference settings associated with the update management facility (36).

Resource (particularly bandwidth) and memory management are important aspects of deployment of the present invention, particularly as it relates to providing updates to the Wireless Device (12). The memory associated with the Wireless Device (12) is generally limited, such that tailoring of updates provided in accordance with the present invention to the capacity of the Wireless Device (12) is desirable. In one particular aspect of the present invention, the update management facility (36) is provided with information regarding the technical parameters of a particular Wireless Device (12). This permits the update management facility (36) to alert the user of the desktop application (24) if parameters of data synchronization enabled by the present invention will not be supported by the Wireless Device (12). Alternatively, the update management facility (36) alerts the user of the desktop application (24) if the parameters of data synchronization may impede optimal performance of the Wireless Device (12). Generally speaking these parameters of data synchronization relate to the quantum of information being sent to the Wireless Device (12) as compared to bandwidth attributes and memory resources available on the Wireless Device (12). For example, if target data for synchronization is selected using the update management facility (36) that constitutes a certain percentage of the memory of the Wireless Device (12), the user will be alerted, and requested to deselect certain data. Generally speaking, the update management facility (36) references data in the database (26) regarding an implementation template for a particular model of a Wireless Device (12). This implementation template is generally based on the parameters of an “average” implementation. In one particular user interface embodiment of the update management facility (36), a user selects a particular model of a Wireless Device (12) from a menu, whereby the corresponding implementation template is accessed and displayed as a series of default values which the user can modify is s/he desires.

Yet another aspect of the update management facility (36) is that based on data provided to this facility, it is adapted to provide a view of how data will appear on the wireless application (22) interface (not shown). It is generally preferable to make adjustments to the appearance of target data, including its organization, on the network-connected device (10) than on the Wireless Device (12).

Another aspect of the update management facility (36) of the present invention is that it permits the renaming of specific fields displayed by the wireless application (22). This is often relatively labor intensive from the Wireless Device (12) itself because of the usual limitations of its input interface. In another representative feature of the update management facility (36) of the present invention, the user can select which specific fields associated with the wireless application (22) to sync, including for example specific subsets of any such fields.

The wireless application (24) is a client application resident on the Wireless Device (12). In accordance with a preferred embodiment of the wireless application (22), the wireless application (22) is not a thin client, but rather a scaled down version of the desktop application (24) of the present invention. This enables a rich user interface and access to resources and functions associated with the target data on the Wireless Device (12) itself, rather than relying on a web server to provision each processing step to a WAP browser, for example. This further provides speed of processing at the Wireless Device (12).

The wireless application (22) can be pre-loaded on the Wireless Device (12) or loaded over the wireless network (16) by selecting the corresponding commands associated with the Wireless Device's (12) input interface.

The wireless application (22) also includes a wireless data management facility (42). The wireless data management facility (42) is substantially the equivalent of the update management facility (36) of the desktop application (24). The wireless data management facility (42) enables the user of the Wireless Device (12) to determine the various settings and preferences associated with the wireless application (22). These settings enable the user of the wireless application (22) to control, for example, the data that is communicated to the Wireless Device (12) from the desktop application (24) via the intermediary server (14). The wireless data management facility (42) also enables the user of the Wireless Device (12) to control the parameters of the communication of data to the wireless application (22) from the desktop application (24) via the intermediary server (14). As in the case of the desktop application (24), these parameters include, for example, the timing of the wireless application (22) obtaining updates from the intermediary server (14).

The wireless application (22) also includes a wireless communication facility (44) that enables communications as between the wireless application (22) and the intermediary server (14), in a manner that is known. Specifically, the wireless communication facility (44) enables data communications in a format that is permitted by the wireless network gateway (20). Specifically, the data communications from the wireless application (22) in the form of updates are associated with the user of the Wireless Device (12), include the IP address of the intermediary server (14), such that the data communication is passed through the wireless network gateway (20) to the intermediary server (14). The data communication is also in a format that the intermediary server (14) recognizes and stores the content of the update in the server database (46) such that the update is linked with the user of the Wireless Device (12), as particularized below.

The wireless application (22) also enables updates to be sent from the wireless application (22) to the desktop application (24) via the intermediary server (14). The categories of data and the parameters of communication of data to the intermediary server (14) are generally selected using the data management facility (36) associated with the desktop application (24).

Despite the above, in one particular embodiment of the present invention the default settings of the Wireless Device (12) as they relate to data synchronization will be as established by means of the desktop application (24). These default settings will be applied unless modified using the Wireless Device (12). In one particular embodiment of the present invention, the wireless application (22) permits the user to turn syncing “ON” or “OFF” but does not permit the user to modify the modalities of syncing as described from the Wireless Device (12).

Therefore, the present invention enables two-way syncing as between the network-connected device (10) and the Wireless Device (12).

One particular aspect of the wireless update management facility (42) is that this facility is aware of the resources available on the Wireless Device (12) memory, whereby the wireless update management facility (42) ceases to add updates in accordance with the invention described and provides the user of the Wireless Device (12) with a warning by means of a suitable message displayed on the Wireless Device (12) screen. This message prompts the user to free up space on the memory (e.g. by deleting data) to free up space for further updates.

As best illustrated in FIG. 4, the intermediary server (14) is connected to the server database (46). The intermediary server (14) is associated with a server application (48) of the present invention. The server application (48) enables the intermediary server (14) to provide the functions particularized herein.

One aspect of the server application (48) is a user access facility (50). The user access facility (50) and the log-in facility (30) of the desktop application (24) cooperate to manage access by users of the desktop application (24) to the resources of the intermediary server (14).

Another aspect of the server application (48) is the database management facility (54) (server side) that is linked with the server database (46). The user access facility (50) and database management facility (54) cooperate to store username/password information provided by the desktop application (24) to the server database (46) such that the server application (48) recognizes data communications received from the communication facility (32) of the desktop application (24) as being associated with a particular authorized user. Specifically, the database management facility (54) creates on the server database (46) a profile associated with a particular authorized user. Incoming data from the Wireless Device (12) and also the desktop application (24), associated with a particular authorized user is linked on the server database (46) with the user profile.

Any updates received from either of the network-connected device (10) or the Wireless Device (12) are stored in the server database (46) such that they are linked with the authorized user. Subsequently, when a request for updates is received from the other of such network-connected device (10) or Wireless Device (12), the server application (48) will respond to such device either with (a) “NO”, i.e. there is no update, or (b) provide the update.

One of the aspects of the user profile is that it contains the database rules for negotiating as between commands from each of the wireless application (22) and the desktop application (24). These database rules are generally established and then modified using the preferences facility (28) associated with the desktop application (24).

In a preferred embodiment of the present invention, the database rules as interpreted by the logic facility (52) of the server application (48) negotiate between the different updates received as part of the two-way syncing described herein.

The database management facility (54) linked to the server application (48) of the present invention will associate a command received from either of a particular Wireless Device (12) or network-connected device (10) with a time stamp. Thereafter the update management facility (36) of the desktop application (24) will obtain the updates from the server application (48), and if an update has a more recent time stamp than corresponding data in the database (26), the update management facility (36) will replace the data with the older time stamp.

Regarding the operation of the wireless update management facility (42) of the present invention, the Wireless Device (12) checks for updates from the intermediary server (14) in a similar fashion. Data with a more recent time space stored to the server database (46) is obtained from the server application (48) and used to replace corresponding data stored to the memory of the Wireless Device (12).

Another aspect of the server application is an administrative facility (not shown) which allows configuration of new users; registration of users for trial accounts; turning accounts “on” or “off” (“off” for example for not having paid their account).

This principle may vary as the parameters of the particular Wireless Device (12) may require. For example, in relation to a BLACKBERRY™

Another function of the user access facility (50) is that it enables the database management facility (54) to map data communicated to the intermediary server (14) either from the desktop application (24) or the wireless application (22). The database management facility (54) maps the data in the server database (46) such that it is associated with particular authorized users. The data base management facility (54) is responsive to data communications from each of the wireless application (22) and desktop application (24) to store data to the server database (46) in such a manner that it is associated with particular authorized user.

Another aspect of the update management facility (36) is that it enables the deletion of data stored to the Wireless Device's memory from the desktop application (24). The updates exchanged as between the desktop application (24) and the wireless application (22) via the intermediary server (14) can include commands to delete particular data stored to the memory. By way of illustration, this can also be accomplished from a BLACKBERRY device to the desktop application. Generally speaking whether deleting on the wireless device (12) also deletes on the desktop is configured as a parameter on the desktop application (29).

The wireless data management facility (42) also enables the deletion of data from the database (26) linked with the desktop application (24) by means of delete commands sent via the intermediary server (14).

Another aspect of each of the update management facility (36) and the wireless update management facility (42) is that each tracks updates and stores same to a log in a manner that is known. This has a number of benefits. For example, this aspect enables creation of a communication history for diagnosis of issues.

It should be understood that another aspect of the present invention is that the desktop application (24) enables the user to control settings associated with the wireless application (22) from the desktop application (29). Because of the limitations of the input devices associated with the average Wireless Device (12), it is practical to control settings associated with the wireless application (22) from the desktop application (24).

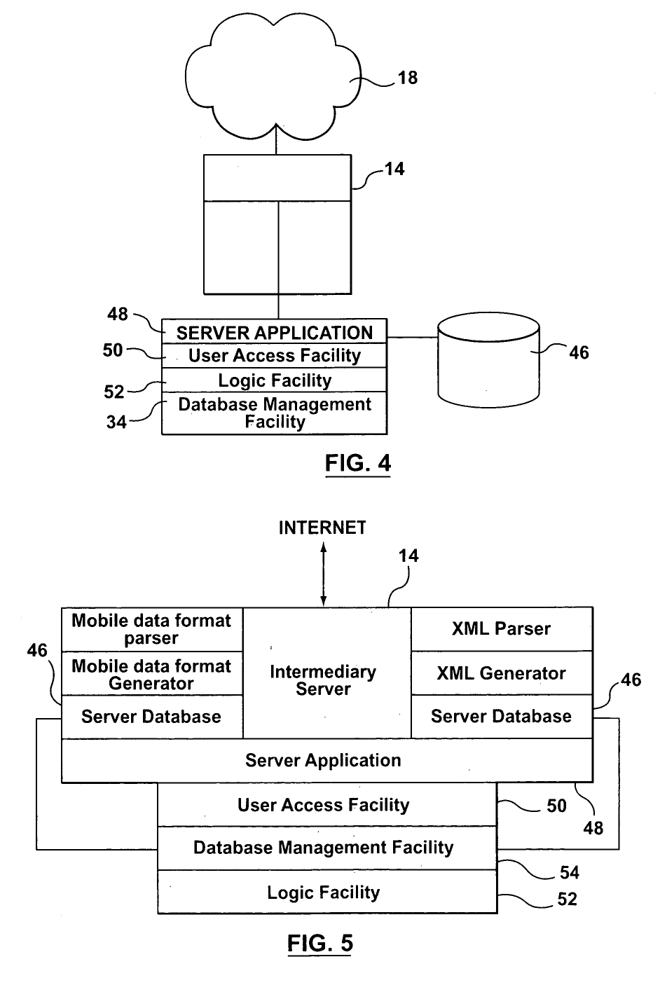

The updates referenced herein, in one embodiment, are provided using XML in a manner that is known. A representative XML scheme is illustrated in FIG. 5a.

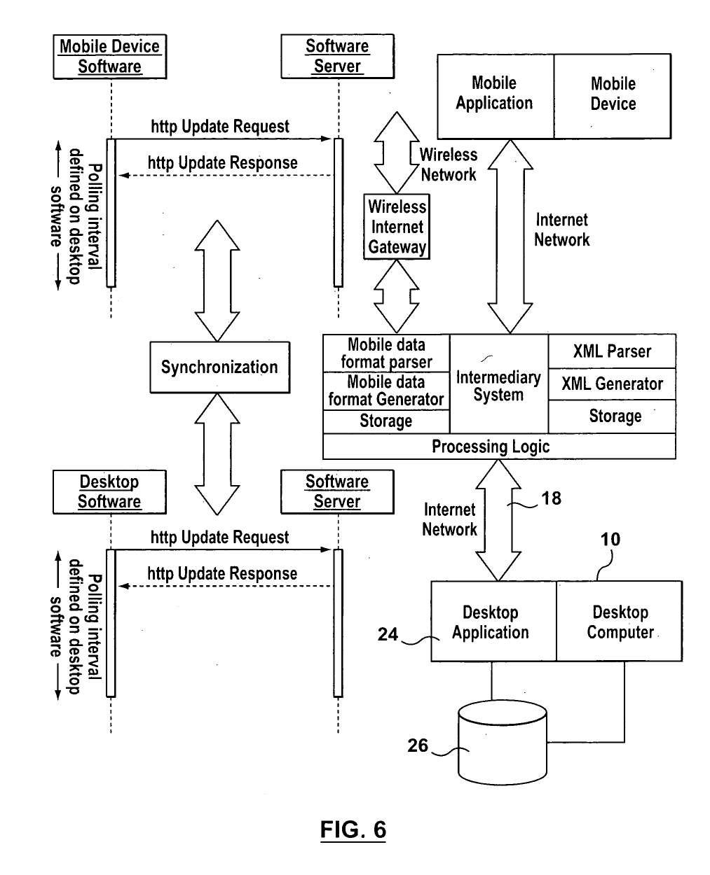

FIG. 6 illustrates a particular embodiment of the intermediary server (14) that illustrates the XML Parser and XML Generator of the server application linked to the intermediary server (14). The Processing Logic illustrated in FIG. 6 is equivalent to the logic facility (52) described above.

In accordance with yet another aspect of the present invention, a software and system architecture is provided whereby each of the desktop application (24) and the wireless application (22) sends updates to the intermediary server (14) based on the communication parameters associated with each of the desktop application (24) and the wireless application (22). These communication parameters depend on the availability of each of the wireless network (16) and the Internet (18) connection of the desktop application (24), and also on the parameters defined by the preferences facility (28) and wireless update management facility (42) as outlined above. Another aspect of the software and system architecture of the present invention is that each of the desktop application (24) and the wireless application (22) polls the intermediary server (14) for updates, also in accordance with communication parameters associated with each of the desktop application (24) and the wireless application (22).

The overall system architecture and its functions is best understood by reference to FIG. 6.

The method of the present invention is best understood as (1) a method for sending updates from a desktop application to one or more wireless devices; (2) a method for sending updates from a wireless application linked to a Wireless Device, to one or more remote computers; and further (3) a method of providing data synchronization as between at least one computer and at least one Wireless Device.

The method for sending updates from a desktop application to one or more wireless devices consists of:
(a) Establishing the criteria of a subset of data stored to a database that consists of target data;
(b) Tracking the target data;
(c) Sending the target data to an intermediary server on a first data synchronization interval; and
(d) Sending the target data to the one on or more Wireless Devices in response to a query from the one or more Wireless Devices as part of a second data synchronization interval.

The method for sending updates from a wireless application linked to a Wireless Device, to one or more remote computers consists of:
(a) Establishing the criteria of a subset of data stored to a memory linked to the Wireless Device that consists of target data;
(b) Tracking the target data;
(c) Sending the target data to an intermediary server on a data synchronization interval; and
(d) Sending the target data to the one on or more remote computers in response to a query from the one or more remote computers as part of a data synchronization interval.

The method of providing data synchronization as between at least one computer and at least one wireless device consists of:
(a) Loading a data synchronization application on each of the at least one computer and the at least one Wireless Device;
(b) Establishing the criteria of a subset of data stored to a memory linked to each of the at least one computer and the at least one Wireless Device, said subset of data consisting of target data, using each such data synchronization application;
(c) Sending target data from each of the at least one computer and the at least one Wireless Device to an intermediary server as part of a data synchronization interval; and
(d) Receiving target data at each of the at least one computer and the at least one wireless application from the other of the at least one computer and the at least one Wireless Device via the intermediary server as part of a data synchronization interval.

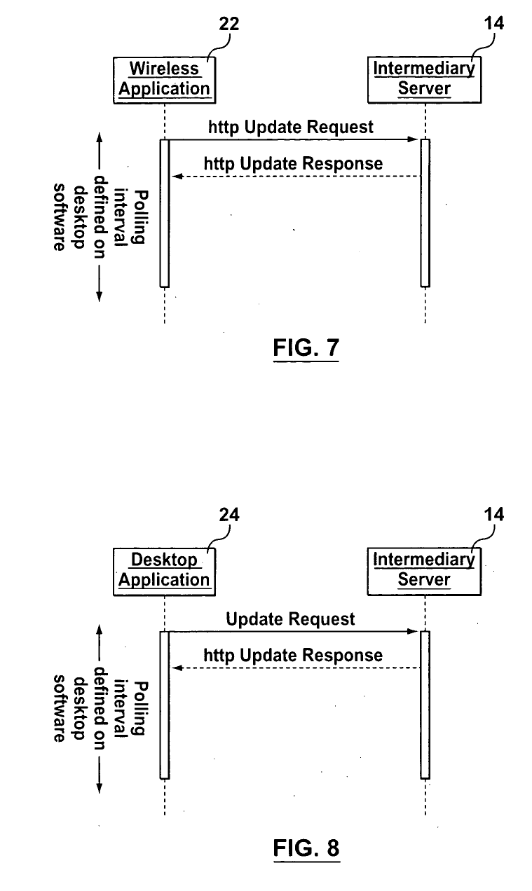

The syncing of data in two directions as between the wireless application (22) and intermediary server (14), and the desktop application (24) and the intermediary server (14) is illustrated in FIGS. 7 and 8 respectively.

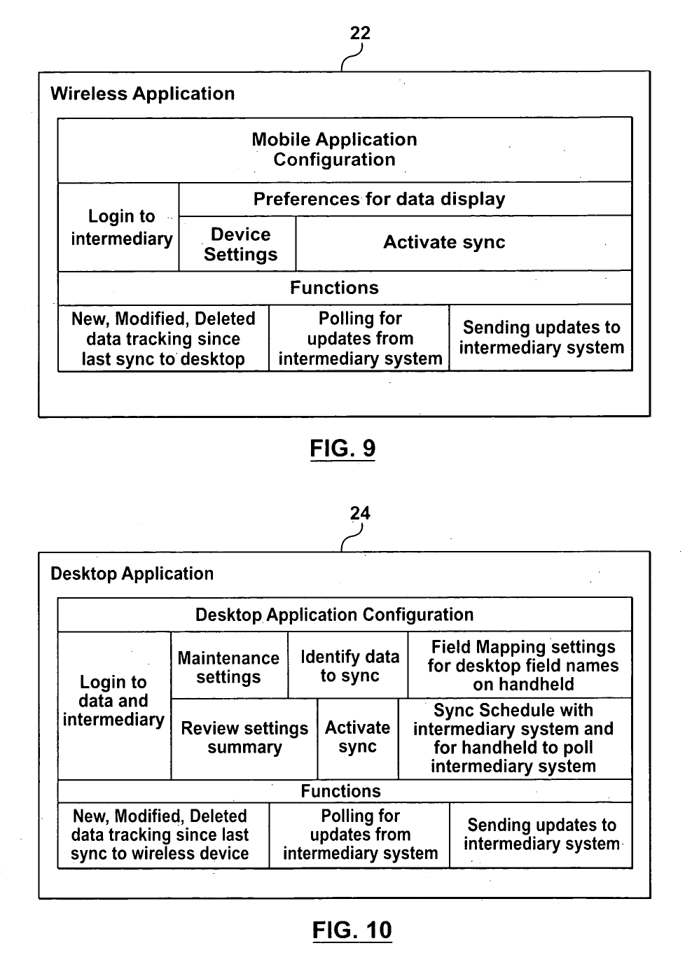

The wireless application (22) enables the processes described above as a series of software functions. These functions are illustrated in FIG. 9.

The desktop application (24) enables the processes described above at the network-connected device (10) also as a series of software functions. These functions are generally illustrated in FIG. 10.

The present invention is also understood as a method for providing customer relationship management based on data synchronization of customer related data as between one or more computers and one or more remote wireless devices.

The present invention is further illustrated by examples of operation thereof.

The present invention is integrated with a known program for managing communications, appointments, task lists, and contact lists such as for example OUTLOOK™. The present invention enables the data synchronization of data associated with OUTLOOK™ to a Wireless Device (12). In a particular embodiment of the present invention, the desktop application (24) will also include an extraction facility (not shown) which enables data associated with OUTLOOK™ to be extracted to a format that is comprehensible to the intermediary server (14) and the wireless application (22) but that promotes efficient allocation of bandwidth and memory resources. For example, in relation to updates including email messages received in OUTLOOK, certain data included in such email messages may be stripped out by the extraction facility before sending the update to the intermediary server (14). For examples, the update may include a header only, whereby the text of the message will only be sent to the Wireless Device (12) in response to a specific request from the Wireless Device (12). Alternatively, the preferences facility (28) and the update management facility (36) enable the wireless application (22) to be configured such that only a specific number of the latest email updates are stored to the memory (for example the five most recent email updates). The remaining email updates, in accordance with this particular aspect of the present invention, would be automatically deleted from the memory by the wireless update management facility (42) of the present invention.

The present invention contemplates various other functions and features that build on the two-way data synchronization capability of the present invention. It should be understood in this regard that it is contemplated that the wireless application (22) is linked or incorporated into a broad range of different applications having various functions.

For example, the present invention enables syncing of financial data with handheld devices such as data from desktop accounting programs such as QUICKBOOKS™ or personal financial management data such as QUICKEN™. The present invention also enables field service data to be synced with a handheld for example, inputting tasks for field service workers which would synchronize the task assigned to particular users directly to their handheld and so on.

CRM applications whereby contacts, calendars, and tasks, customer histories, customer order histories etc. are synced with a mobiles sales team from a desktop system is also contemplated.

It should be understood that one of the advantages of the present invention over prior art solutions, including WAP implementations, is that data that has already been obtained from the intermediary server (14) need not be reloaded over the wireless network (16) but can be simply displayed in the wireless application (22) or an associated application (22) loaded on the Wireless Device (12). Small packets of data can be synced in accordance with the present invention which can occur almost transparently to the end-user providing a seamless experience. With a WAP type solution, the amount of data that would travel via the wireless network (16) may often take too much time for any kind of useful experience at viewing the data.

Another advantage of the present invention is that the wireless application (22) is easily provided with processing logic without the need to access the wireless network (16). This generally provides improved logic and user interface control that in turn improves response time, usability and reduces the amount of network calls. This represents a significant cost saving also.

The present invention contemplates the inclusion of appropriate security utilities and measures. For example, the network-connected device (10) and the Wireless Device (12) of the present invention can communicate to the intermediary server (14) using security protocol, or field level encryption in a PKI implementation.

It should be understood that the present invention can be built on platforms different from J2ME such as for example JAVA, BREW or SYMBIAN.

Other variations or extensions are possible. For example, an e-commerce application can be linked to the intermediary server (14) along with a billing module for tracking and charging for usage of the resources thereof. The present invention can be used for sending images to a Wireless Device (12) for showing same to friends and family.

1. A system for enabling wireless data synchronization between a client computer and a wireless device comprising:
(a) A client computer including a client application, and linked to a database;
(b) A wireless device including a wireless application, and linked to a memory; and
(c) An intermediary server operable to connect to each of the client computer and the wireless device, the intermediary server including a server database;
Wherein the client application includes an update management facility that is operable to enable a user of the client computer to:
(i) selectively determine one or more data objects on the database for synchronization as between the intermediary server and the wireless device; and
(ii) establish one or more parameters of synchronization as between the intermediary server and the wireless device;
Wherein the client computer is operable to communicate the data objects to the intermediary server, which data objects are stored by the intermediary server to the server database; and
Wherein the wireless application is operable to poll the intermediary server for one or more updates including the data objects from the client computer and in response to such polling the intermediary server is operable to retrieve the data objects from the server database and communicate such data objects to the wireless device.

2. The system as claimed in claim 1, wherein the client application is operable to poll the intermediary server for one or more updates including data objects defined on the wireless device, such updates being defined by a user of the wireless device by operation of the wireless application, and in response to such polling the intermediary server is operable to retrieve the data objects from the server database and communicate such data objects to the client computer.

3. The system claimed in claim 1, wherein the client application also includes a data mapping facility that is operable to map data associated with the database so as to define one or more data categories that determine data resident on the database that is available for synchronization by operation of the update management facility.

4. The system as claimed in claim 3, wherein the client application also includes an extraction facility that co-operates with the data mapping facility so as to extract data from the database selected for synchronization by application of the one or more categories of data in a format optimized for one or more of:
(a) data format requirements defined by the wireless device; and/or
(b) optimization of resources of the wireless device.

5. The system as claimed in claim 1, wherein the update management facility enables the selective exchange of updates as between the client computer and the wireless device, via the intermediary server.

6. The system as claimed in claim 1, wherein the update management facility is operable to enable the user of the client computer to define the time parameters for data synchronization as between the client computer and the wireless device.

7. The system as claimed in claim 1, wherein the update management facility is further operable to define a list of identifiers for a plurality of wireless devices, and upon the user selecting the identifier for the wireless device, the update management facility being operable to associate with the wireless device optimal data synchronization parameters for the wireless device.

8. The system as claimed in claim 7, wherein the update management facility is operable to enable a user to define on the client computer one or more user preferences associated with the presentation of the updates on the client computer.

9. The system as claimed in claim 8, wherein the parameters defining the presentation of the updates on the client computer include the naming of one or more fields associated with the wireless application.

10. The system as claimed in claim 1, wherein the update management facility is operable to delete data from the memory of the wireless device based on user input to the client computer.

11. The system as claimed in claim 1, wherein the wireless application generally consists of a scaled down version of the client application.

12. The system as claimed in claim 1, wherein the wireless application includes a wireless data management facility, wherein the wireless data management facility is operable to permit a user of the wireless device to define one or more parameters of synchronization as between the wireless device and the client computer, wherein the wireless data management facility in co-operation with the wireless device is operable to:
(a) Communicate the one or more parameters of synchronization defined on the wireless device to the intermediary server; and
(b) Establish commands linked to the one or more parameters of synchronization so as to instruct the intermediary server to communicate the one or more parameters of synchronization to the client computer.

13. The system as claimed in claim 1, wherein the client computer and the intermediary server are operable to engage in Internet based communications.

14. The system as claimed in claim 13, wherein the client application includes a client communication utility, and the client application is operable to assemble an electronic communication that includes an IP address for the intermediary server and the data objects in a format understood by the intermediary server.

15. The system as claimed in claim 1, wherein the wireless application includes a wireless communication utility, wherein the wireless communication utility is operable to assemble communications permitted by a wireless network gateway associated with the intermediary server, wherein the wireless application is operable to assemble one or more communications including updates identified for delivery to the client computer by the intermediary server.

16. The system claimed in claim 15, wherein the wireless data management facility is operable to:
(a) determine the technical parameters of the wireless device related to its ability to receive and/or process updates; and/or
(b) to limit the receipt and/or processing of updates based on such technical parameters; and/or
(c) to alert the user of the wireless device to free up space on a memory linked to the wireless device to enable the receipt and/or processing of further updates.

17. The system as claimed in claim 2, wherein the intermediary server is linked to a server application, wherein the server application includes:
(a) a user access facility that manages the access of one or more authorized users from the client computer and/or from the wireless device to resources of the intermediary server; and
(b) a database management facility that is operable to link data objects sent to the intermediary server and stored to the server database with the applicable client computer and/or wireless device, and/or one or more applicable authorized users.

18. The system as claimed in claim 17, wherein the database management facility is operable to define one or more database rules for negotiating at the intermediary server between one or more commands received from each of the client computer and the wireless device.

19. The system as claimed in claim 18, wherein the database management facility is operable to associate with each update received from one or more of the client computer or the wireless device with a time stamp, wherein data stored to the database of the client computer and/or the memory of the wireless device is updated based on the update stored to the server database with the most recent time stamp.

20. A computer program for use on a client computer, the client computer being linked to a database, for managing data synchronization as between the client computer and a wireless device via an intermediary server operable to connect to each of the client computer and the wireless device, the intermediary server including a server database, the computer program comprising instructions for defining on the client computer:
(a) An update management facility that is operable to enable a user of the client computer to:
(i) selectively determine one or more data objects on the database for synchronization as between the intermediary server and the wireless device; and
(ii) establish one or more parameters of synchronization as between the intermediary server and the wireless device;
Wherein the client computer is operable to communicate the data objects to the intermediary server, which data objects are stored by the intermediary server to the server database; and
Wherein the wireless device by operation of a wireless application polls the intermediary server for one or more updates from the client computer, and in response to such polling the intermediary server is operable to retrieve the data objects from the server database and communicate such data objects to the wireless device.

21. A server computer program for use on a server computer, the server computer consisting of an intermediary server enabling data synchronization as between at least one client computer and at least one wireless device, the server computer program comprising instructions for defining on the server computer:
(a) a communication utility that enables communications between the intermediary server and each of the client computer and the wireless device;
(b) a user access facility that manages the access of one or more authorized users from the client computer and/or from the wireless device to resources of the intermediary server; and
(c) a database management facility that is operable to link data objects sent to the intermediary server from the client computer and/or the wireless device and stored to the server database with the applicable client computer and/or wireless device, and/or one or more applicable authorized users;
wherein the server computer program is operable to enable the server computer to receive polling requests from each of the client computer and/or the wireless device, and in response to provide one or more updates to the other of the client computer and/or the wireless device, the updates consisting of data objects stored to the server database for synchronization, thereby achieving data synchronization as between the client computer and the wireless device.

22. A method for providing data synchronization as between at least one client computer and at least one wireless device comprising the steps of:
(a) Loading a data synchronization application on each of the at least one client computer and at least one wireless device;
(b) Establishing one or more criteria for a subset of data stored to a memory linked to each of the at least one client computer and the at least one wireless device, said subset of data consisting of target data for one or more updates, by operation of the data synchronization application;
(c) Defining parameters for delivery of the one or more updates from one of the at least one client computer or the at least one wireless device to the other of the at least one client computer or the at least one wireless device, by operation of the data synchronization application;
(d) Sending one or more updates from each of the at least one client computer and the at least one wireless device to an intermediary server as part of a data synchronization routine; and
(e) Receiving updates at each of the at least one client computer or the at least one wireless device from the other of the at least one client computer or the at least one wireless device, via the intermediary server, by engaging the data synchronization routine from the at least one client computer or the at least one wireless device.
